(19) United States
(12) Patent Application Publication
(10) Pub. No.: US 2020/0309609 A1
(43) Pub. Date: Oct. 1, 2020

(54) SYSTEM AND METHOD FOR NON-INVASIVE HEAT MEASUREMENT

(71) Applicant: Panoramic Power Ltd., Kfar-Saba (IL)

(72) Inventors: Yaron RAM, Holon (IL); Yehoshua ROSENBERG, Nokdim (IL); Adi SHAMIR, Kidron (IL)

(73) Assignee: Panoramic Power Ltd., Kfar-Saba (IL)

(21) Appl. No.: 16/836,114

(22) Filed: Mar. 31, 2020

Related U.S. Application Data
(60) Provisional application No. 62/827,508, filed on Apr. 1, 2019.

(51) Int. Cl. G01K 17/10

(52) U.S. Cl. CPC G01K 17/10

(57) ABSTRACT

A heat measurement apparatus and method for a non-invasive measurement of heat generation are provided. The method include determining a flow value of a flowing substance within a system based on a system power usage; and determining a heat energy value of a system based on a temperature difference of a first temperature of the flowing substance at an inlet of the system from a second temperature of the flowing substance at an outlet of the system and the flow value of the system.

### CROSS-REFERENCE TO RELATED APPLICATIONS

This application claims the benefit of U.S. Provisional Application No. 62/827,508 filed on Apr. 1, 2019, the contents of which are hereby incorporated by reference.

### TECHNICAL FIELD

The present disclosure relates generally to heat measurements and more particularly to a system and method of non-invasive heat measurement.

### BACKGROUND

In systems that require determining heat values for a variety of purposes, temperature measurements often are performed by invasive sensors. That is, both flow sensors and temperature sensors are inserted into the system, e.g., into ventilation ducts or transmission lines, for the purpose of determining a current heat energy value within certain areas of the system. Many such measurements are not needed on a permanent basis, and therefore the insertion of these invasive meters can be cumbersome, expensive, and potentially damaging to the existing system.

A variety of solutions exist that are invasive by nature where at least one of the two types of sensors used is invasive. In one example, temperature sensors configured to determine the change of temperature over a period of time, or ΔT, of the measured system are mounted externally on the inbound and outbound flow of the system and an internal flow sensor is mounted within the system. For example, the sensor may be mounted within a pipe carrying air or another liquid, to allow flow to pass therethrough and measure the flow of the pipe. However, the invasive nature of such a system creates inefficiencies and both within the system itself, as the sensors can affect the flow, as well as with regard to the accuracy of the temperature measurements, which may be affected by the invasive sensors.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for a non-invasive measurement of heat generation, the method including: determining a flow value of a flowing substance within a system based on a system power usage; and determining a heat energy value of a system based on a temperature difference of a first temperature of the flowing substance at an inlet of the system from a second temperature of the flowing substance at an outlet of the system and the flow value of the system.

Certain embodiments disclosed herein also include a non-transitory computer readable medium having stored thereon instructions for causing a processing circuitry to perform a process, the process including: determining a flow value of a flowing substance within a system based on a system power usage; and determining a heat energy value of a system based on a temperature difference of a first temperature of the flowing substance at an inlet of the system from a second temperature of the flowing substance at an outlet of the system and the flow value of the system.

Certain embodiments disclosed herein also include system for a non-invasive measurement of heat generation, including: a processing circuitry; and a memory, the memory containing instructions that, when executed by the processing circuitry, configure the system to: determine a flow value of a flowing substance within a system based on a system power usage; and determine a heat energy value of a system based on a temperature difference of a first temperature of the flowing substance at an inlet of the system from a second temperature of the flowing substance at an outlet of the system and the flow value of the system.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a block diagram of a system for heat measurement according to an embodiment.

FIG. 1B is a schematic diagram of a deployment of components of the heat measurement system according to an embodiment.

FIG. 1C is an example chart of a power usage versus flow relationship of a pump used to cause a flow of a substance to provide heat to a heat exchanger of a system according to an embodiment.

FIG. 2 is a flowchart of a method for non-invasive heat measurement according to an embodiment.

FIG. 3 is a block diagram of a SPPS according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various example embodiments disclosed herein provide for a non-invasive heat measurement solution. In an embodiment, the disclosed solutions provide for a first temperature sensor affixed to an inlet of a pipe, a second temperature sensor affixed to an outlet of a pipe and an electrical current sensor. The second sensor is used to determine the current consumed by a pump causing a flow through the pipe. In an embodiment, the second a non-invasive self-powered power sensor (SPPS). Information from the first and second temperature sensors is used to determine a temperature difference (ΔT) between the inlet and the outlet flow. Information about the electrical current is used to determine the flow through the pipe using conversion diagrams between electrical current and flow characterizing the pump, e.g., based on a predetermined correlation. The ΔT and the flow rate information can then be used to determine the rate of heat generation.

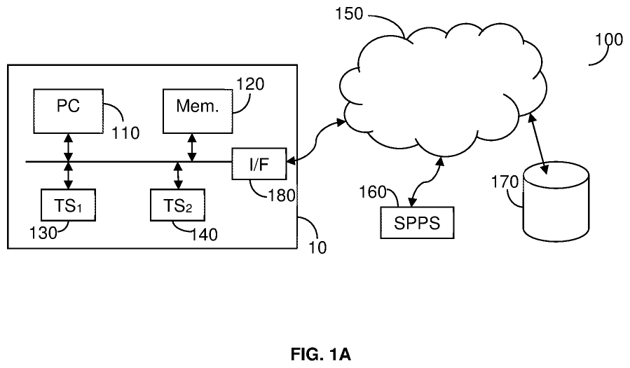

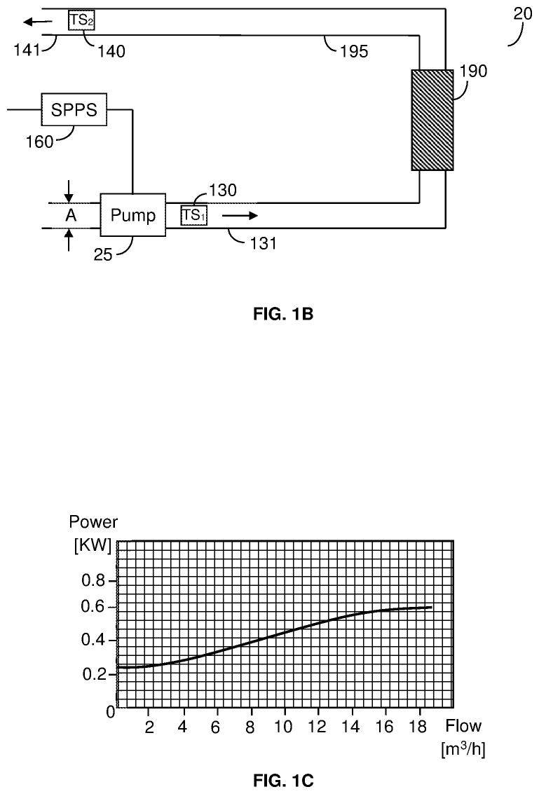

FIG. 1A is an example block diagram of a system 100 for heat measurement designed according to an embodiment. Reference is further made to FIG. 1B that shows a schematic diagram of a deployment of components 20 of the heat measurement system 100 according to an embodiment. In an embodiment, a heat measurement apparatus 10 comprises a processing circuitry (PC) 110 connected to a memory 120, and a network interface 180.

The processing circuitry 110 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 120 may include or be a combination of volatile and non-volatile memory used for both storing firmware of the measurement unit 10, as well as being used for the operations performed by the PC 110, for example but with no limitation, a scratch pad memory. In another embodiment, the memory 120 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the PC 110 to perform the various processes described herein.

A network interface 180 provides connectivity between the heat measurement apparatus 10 and its components, for example the PC 110 and the memory 120, and the external world, for example, to a network 150. The network interface 180 may provide wired or wireless connectivity to the network 150. The network 150 may include, but is not limited to, a local area network (LAN), wide area network (WAN), metro area network (MAN), the Internet, the worldwide web (WWW), wired or wireless and any combinations thereof.

The heat measurement apparatus 10 further includes a first temperature sensor (TS₁) 130 adapted to be affixed in proximity of an inlet 131 of a pipe 195 of FIG. 1B, through which a flowing substance is fed therethrough. The measurement unit 10 further comprises a second temperature sensor (TS₂) 140 adapted to be affixed in proximity of an outlet 141 of the pipe 195.

One or more data sources 170, e.g., databases, may be connected to the network 150. In an embodiment, the one or more data sources 170 are used to provide predetermined manufacturer relationships between electrical power usage and flow rates of, for example, a pump 25 configured to create a flow of the flowing substance through the pipe 195. Different pumps may have different power versus flow relationships, and thus the heat measurement apparatus 10 must be adapted to enable the determination of appropriate data for a particular pump used. In one embodiment, the relationships used to determine the correct data is provided by a user of the measurement apparatus 10 either directly through a user interface (UI) of the measurement apparatus 10, or remotely connecting to the measurement apparatus 10.

FIG. 1C shown an example chart of a power usage versus flow relationship of a pump used to cause a flow of a substance to provide heat to a heat exchanger 190 within a system according to an embodiment.

For the purpose of measuring the power consumption of the pump 25, which may include the electrical current usage over time, a non-invasive power sensor, such as a self-powered power sensor (SPPS) 160, is affixed to an input lead providing power to the pump 25. An example implementation of the SPPS 160 is provided and further described in U.S. Pat. No. 9,134,348, (hereinafter the '348) titled “Distributed Electricity Metering System” assigned to common assignee and hereby incorporated by reference.

As discussed in the '348 reference, the SPPS 160 is configured to communicate wirelessly with the heat measurement apparatus 10 either directly or indirectly through the network 150. This should not be viewed as limiting the scope of the disclosed embodiment an any manner, as it is specifically noted that wired techniques to measure electrical power consumption are known and may be similarly employed with respect of the measurement unit 10.

The PC 110, operating based on instructions stored in the memory 120, is configured to collect the temperature readings from the TS₁ 130, TS₂ 140, and the current sensor 160. The PC 110 is further configured to receive the power versus flow curve of the particular pump 25 used, e.g., from a database 170 through the network 150. The flow curve may be provided as a graph, a chart or a table as needed. Based on this information it is possible to determine the heat as explained herein in more detail.

The heat energy value of the system is represented by the following equation:

Q=mcΔT=ρAvΔtcΔT Eq. 1

where Q is the heat energy; m is the substance mass; c is the heat capacity of the substance at room temperature in atmospheric pressure, e.g., for water this is 4.136 J/g° C.; ΔT is the temperature difference which is calculated by subtracting the temperature measured by TS₁ 130 from the temperature measured by TS₂ 140; ρ is the density of the flowing substance, e.g., approximately 1,000 Kg/m³ for water; A is the surface area of the pipe which is a known parameter; v is the flow speed of the substance within the pipe; and, Δt is a measurement of a time lapse.

Thus, the heat energy is equal to a volume of substance measured per time unit, allowing for the determination of heat per a specified time period. Therefore, by performing the measurement of ΔT and extracting, from the power versus flow chart of a known pump, the flow in units of volume per time period for a particular power consumption measured, the heat energy Q can be determined without access to the additional variables. That is, using the graph 1C and knowing delta T it is possible to compute the Q without needing to compute all the other variables shown in the equation on the right side because they are already included when you do the calculation for the pump.

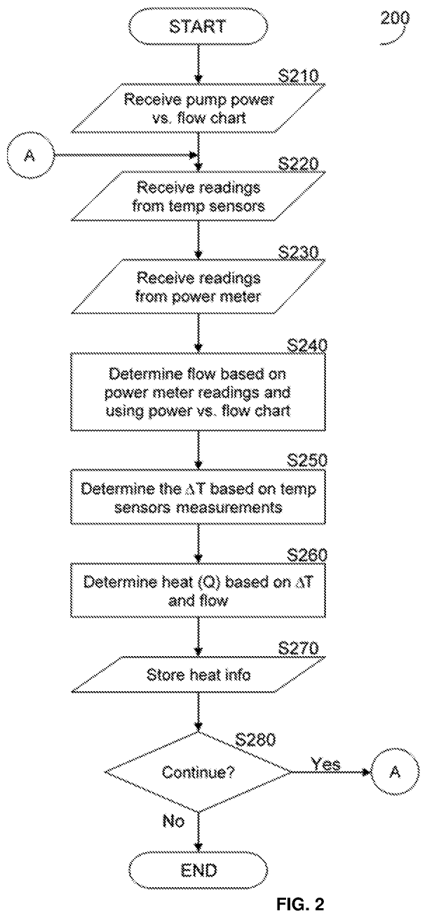

FIG. 2 is an example flowchart 200 of method for non-invasive heat measurement according to an embodiment. In an example configuration, the method is performed by the heat measurement apparatus 10.

At S210, pump characteristics for conversion from power or current consumption to flow are received, e.g., from a database storing predetermined manufacturing specifications for known pumps. Typically, this relation only needs to be determined once, as this relationship, an example of which is shown in FIG. 1C, does not typically change. However, in an embodiment, periodic updates of the graph may be necessary if, for example, these characteristics change over time.

At S220, temperature readings are received from an inlet and an outlet of a system, e.g., the inlet and outlet of a pipe of the system configured to transfer a flowing substance therethrough, and where the temperature readings are received from wireless temperature sensors.

At S230, readings of power consumption, or current consumption, of a system are received, e.g., from an SPPS that provides power information of a pump configured to create a flow of the flowing substance.

At S240, the flow of the substance driven by the pump is determined based on the power or current readings and the pump characteristics, allowing for a determination of flow value based on power consumption information. Such a determination may include several steps of converting a plurality of power readings received from an SPPS to a flow value. In an embodiment, a flow value of the flowing substance within a system is determined based on a predetermined chart correlating power usage to flow value.

At S250, the temperature difference ΔT between the outlet measurement and inlet measurement of temperature of the system is determined by subtracting the temperature reading received a first sensor placed in proximity of the inlet from the temperature reading received from a second sensor placed in proximity of an outlet.

At S260, the heat value Q is determined based on the variable ΔT and flow, as explained above in discussion of FIG. 2C.

At optional S270, the value of Q is stored in a memory, e.g., within a database, for future use. It may be stored with a timestamp to indicate when the value determination was calculated. Other parameters may be stored therewith, including and without limitation, the power or current consumption, the value of ΔT, the relevant chart, and the like.

At S280, it is checked whether to continue the method, and if so, execution continues with S220; otherwise, execution terminates.

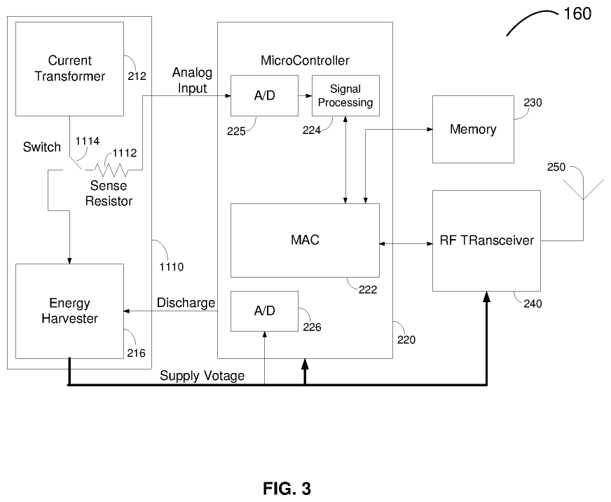

FIG. 3 shows an example block diagram of a SPPS 160 according to an embodiment.

In an embodiment, the SPPS 160 includes an analog section 1110 that comprises a current transformer 212, an energy harvester 216, a switch 1114 and a sense resistor 1112. In normal operation the switch 1114 is positioned to enable energy harvesting by the energy harvester 216. Periodically, for example under the control of the microcontroller 220, the switch 1114 is activated to short the secondary winding of transformer 212 through the sense resistor 1112, typically having a low resistance. The voltage on the sense resistor 1112 is sampled by the ADC 225.

In order for the system SPPS 160 to identify a voltage peak the process is repeated several times in each cycle. The switch 1114 is toggled between the two positions to enable energy harvesting most of the time in a first position, and measurement of the voltage periodically when in the second position. The sampling is averaged over a number of cycles and divided by the resistance value of the sense resistor 1112 to provide the current value. The current value is then multiplied by a time interval to obtain the total charge value, for example, in Ampere Hours.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for a non-invasive measurement of heat generation, comprising:
determining a flow value of a flowing substance within a system based on a system power usage; and
determining a heat energy value of a system based on a temperature difference of a first temperature of the flowing substance at an inlet of the system from a second temperature of the flowing substance at an outlet of the system and the flow value of the system.

2. The method of claim 1, further comprising:
receiving the first temperature using a first temperature sensor placed in proximity of the inlet of a pipe of the system; and
receiving the second temperature using a second temperature sensor placed in proximity of the outlet of the pipe of the system.

3. The method of claim 1, further comprising:
determining a flow value of the flowing substance within the system is based on a predetermined chart correlating the system power usage to a flow value.

4. The method of claim 3, wherein the predetermined chart is provided as an equation describing the system power usage to flow value correlation.

5. The method of claim 1, wherein the system power usage is determined based on measurements from a self-powered power sensor (SPPS).

6. The method of claim 1, wherein the flowing substance is water.

7. The method of claim 1, further comprising:
storing the determined heat energy value in a database.

8. The method of claim 7, further comprising:
storing the temperature difference in the database in association with the heat energy value.

9. The method of claim 7, further comprising:
storing the system power usage in the database in association with the heat energy value.

10. A non-transitory computer readable medium having stored thereon instructions for causing a processing circuitry to perform a process, the process comprising:
determining a flow value of a flowing substance within a system based on a system power usage; and
determining a heat energy value of a system based on a temperature difference of a first temperature of the flowing substance at an inlet of the system from a second temperature of the flowing substance at an outlet of the system and the flow value of the system;

11. A heat measurement apparatus for a non-invasive measurement of heat generation, comprising:
a processing circuitry; and
a memory, the memory containing instructions that, when executed by the processing circuitry, configure the apparatus to:
determine a flow value of a flowing substance within a system based on a system power usage; and
determine a heat energy value of a system based on a temperature difference of a first temperature of the flowing substance at an inlet of the system from a second temperature of the flowing substance at an outlet of the system and the flow value of the system.

12. The apparatus of claim 11, wherein the apparatus is further configured to:
receive the first temperature using a first temperature sensor placed in proximity of the inlet of a pipe of the system; and
receive the second temperature using a second temperature sensor placed in proximity of the outlet of the pipe of the system.

13. The apparatus of claim 12, wherein the first temperature sensor and the second temperature sensor are connected to the heat measurement apparatus.

14. The apparatus of claim 11, wherein the apparatus is further configured to:
determine the flow value of the flowing substance within the system based on a predetermined chart correlating the system power usage to a flow value.

15. The apparatus of claim 14, wherein the predetermined chart is provided as an equation describing the system power usage to flow value correlation.

16. The apparatus of claim 11, wherein the system power usage is determined based on measurements from a self-powered power sensor (SPPS).

17. The apparatus of claim 11, wherein the flowing substance is water.

18. The apparatus of claim 11, wherein the apparatus is further configured to:
store the determined heat energy value in a database.

19. The apparatus of claim 18, wherein the apparatus is further configured to:
store the temperature difference in the database in association with the heat energy value.

20. The apparatus of claim 18, wherein the apparatus is further configured to:
store the system power usage in the database in association with the heat energy value.
